(19) United States
(12) Patent Application Publication
(10) Pub. No.: US 2023/0234043 A1
(43) Pub. Date: Jul. 27, 2023

(54) LIQUID SAMPLE DELIVERY DEVICE

(71) Applicants: Richard NEUTZE, Västra Frölunda (SE); Swagatha GHOSH, Mölndal (SE); Gisela BRÄNDÉN, Göteborg (SE); Peter DAHL, Ljungskille (SE)

(72) Inventors: Richard NEUTZE, Västra Frölunda (SE); Swagatha GHOSH, Mölndal (SE); Gisela BRÄNDÉN, Göteborg (SE); Peter DAHL, Ljungskille (SE)

(73) Assignee: SERIAL X AB, Göteborg (SE)

(21) Appl. No.: 17/999,423

(22) PCT Filed: May 28, 2021
(86) PCT No.: PCT/SE2021/050501

§ 371 Date: Nov. 21, 2022

(30) Foreign Application Priority Data
Jun. 2, 2020 (SE) 2030180-0

(51) Int. Cl. B01L 3/02; B05B 1/02; G01N 23/20025; B05B 5/053; B05B 7/06

(52) U.S. Cl. CPC B01L 3/021; B05B 1/02; G01N 23/20025; B01L 3/0275; B05B 5/0533; B05B 7/066; B01L 2300/0832; B01L 2400/0487; G01N 2223/203; G01N 2223/307; G01N 2223/612

(57) ABSTRACT

Specimen delivery device for the delivery of a liquid sample to be analysed comprising: a proximal end, and a distal end. The distal end being longitudinally displaced from the proximal end of the device. The device comprises a base at the proximal end for releasable connection to a magnetic sample holder of a liquid sample analysis device. The device further comprises a longitudinally extending projection having a radial inner portion, the projection extending from the base towards the distal end, the projection being arranged for receiving and holding a sheath. The device comprises at least one fluidic conduit, the fluidic conduit extending at least partially longitudinally within the radial inner portion, the fluidic conduit for the delivery of a liquid sample for analysis.

### FIELD OF THE INVENTION

The present disclosure relates to a device for delivery of a liquid sample to a liquid sample analysis device. Specifically, it relates to a liquid sample delivery device comprising a base for releasable connection to a magnetic sample holder, a projection and a fluidic conduit.

### BACKGROUND OF THE INVENTION

Serial crystallography is a method in structural biology developed for X-ray diffraction studies using X-ray free electron lasers (XFELs) or synchrotron radiation facilities. Serial crystallography is distinct from traditional approaches to macromolecular crystallography for which larger crystals are flash-frozen in liquid nitrogen and X-ray diffraction data are recorded from a single crystal at low temperature. Since serial crystallography data are collected at room temperature, this is more physiologically relevant, and artefacts of cooling are avoided. Via serial crystallography biological reactions can be initiated in microcrystals and time-resolved diffraction used to study structural changes during enzyme catalysis, ligand binding, or unbinding, and light-sensitive reactions. The largest remaining barrier to increased use of serial crystallography is the lack of standardization for sample delivery. Facilities supporting serial crystallography generally have bespoke sample delivery systems requiring dedicated expertise, which is a heavy burden for a traditional protein crystallography beamline at a synchrotron radiation facility. An example of a device for the delivery of a liquid sample/specimen within serial crystallography, commonly called a microjet is shown in U.S. Pat. No. 9,821,325 B2 (Arizona State University). The device is an arrangement of plungers and valves forming an injector apparatus for use in aqueous and lipidic cubic phase (LCP) injection.

However, generally, each microjet needs to be custom-made and is therefore too expensive for most protein crystallographers to duplicate in their home-laboratory.

Furthermore, in addition to serial crystallography liquid sample delivery systems and devices are used in x-ray solution scattering studies and spectroscopic studies.

Simpler, less costly systems for the delivery of a liquid sample would be advantageous.

### SUMMARY OF THE INVENTION

Accordingly, the present invention preferably seeks to mitigate, alleviate or eliminate one or more of the above-identified deficiencies in the art and disadvantages singly or in any combination and solves at least the above-mentioned problems by providing a specimen delivery device for the delivery of a liquid sample to be analysed comprising: a proximal end, and a distal end. The distal end being longitudinally displaced from the proximal end of the device. The device comprises a base at the proximal end for releasable connection to a magnetic sample holder of a liquid sample analysis device. The device further comprises a longitudinally extending projection having a radial inner portion, the projection extending from the base towards the distal end, the projection being arranged for receiving and holding a sheath. The device comprises at least one fluidic conduit, the fluidic conduit extending at least partially longitudinally within the radial inner portion, the fluidic conduit for the delivery of a liquid sample for analysis.

A method of analysing a sample is also provided.

A system for analysis of a liquid sample is provided.

Further advantageous embodiments are disclosed in the appended and dependent patent claims.

### BRIEF DESCRIPTION OF THE DRAWINGS

These and other aspects, features and advantages of which the invention is capable will be apparent and elucidated from the following description of embodiments of the present invention, reference being made to the accompanying drawings, in which

FIG. 1 is perspective view of a specimen delivery device according to an aspect.

FIG. 2 is a perspective view of a specimen delivery device comprising two fluidic conduits according to an aspect.

FIG. 3 is a perspective view of a specimen delivery device comprising a sheath and a connecting element according to an aspect.

FIG. 4 is a perspective view of a gas delivery sleeve according to an aspect.

FIG. 5 is a schematic representation of a system comprising a specimen delivery device, a liquid sample analysis device and a means for delivery a liquid according to an aspect.

FIG. 6 is a perspective cross-sectional view of a specimen delivery device according to an aspect.

FIG. 7 is a perspective view of a specimen delivery device according to an aspect. The fluidic conduit is shown with dotted lines.

### DETAILED DESCRIPTION

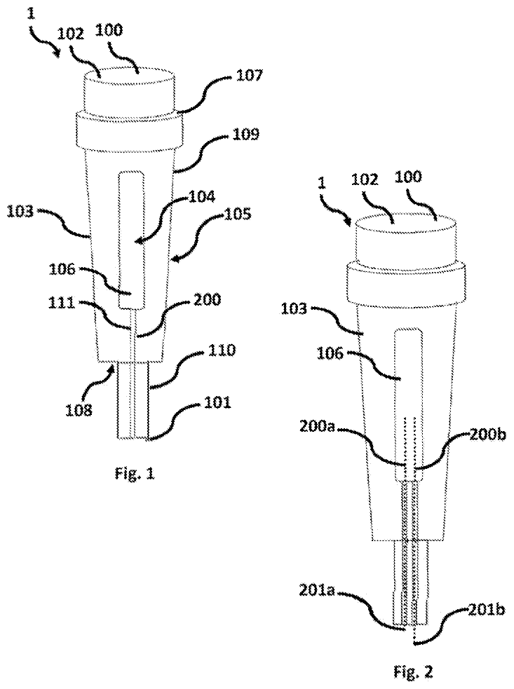

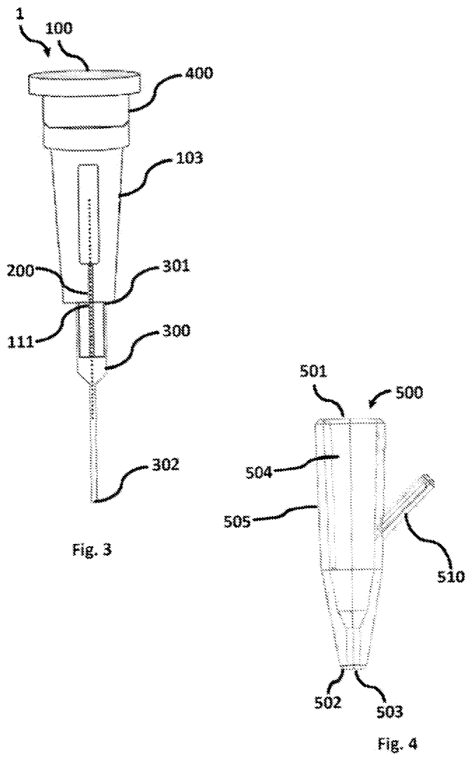

FIGS. 1 to 5 show a specimen a specimen delivery device 1 for the delivery of a liquid sample to be analysed. The device comprises a proximal end 100, and a distal end 101. The distal end 101 is longitudinally displaced from the proximal end 100. The proximal end 100 of the device has a base 102 for releasable connection to a magnetic sample holder 20 in a liquid sample analysis device 2. The device 1 further comprises a longitudinally extending projection 103, the projection 103 extending from the base 102 to the distal end 101 of the device 1. The projection 103 is arranged for receiving a sheath 300. The projection 103 has a radial inner portion 104. The device 1 is provided with at least one fluidic conduit 200 for delivery of a liquid sample to be analysed. The fluidic conduit 200 extends at least partially longitudinally within the radial inner portion 104 of the projection 103. The fluidic conduit 200 forms a continuous sealed path for fluid flow. The continuous sealed path of the fluidic conduit 200 guides fluid e.g., the liquid sample, to the outlet 201.

The device 1 provides a simple and effective means of providing a liquid sample to a liquid sample analysis device 2, such as an x-ray crystallography unit. Alignment of the fluidic conduit 200 within the device 1 is achieved by the projection 103. Furthermore, the device 1 is agnostic with respect to the delivery mechanism for fluids to the analysis device. Traditionally devices for the delivery of a liquid sample to for example, an x-ray crystallography unit comprise complex arrangements of pumping mechanism and valves within the device, and therefore comprise non-continuous fluid paths. The present device 1 enables the use of standard mounts to maintain the fluidic conduit 200 in position and simplifies the construction and operation of the device as the actuation force for liquid displacement within the device is provided externally.

The interaction of the base 102 and the magnetic sample holder 20 enables simple alignment of the device 1 within a liquid sample analysis system. For example, it may reduce the need for delivery a stream of liquid for alignment purposes which is subsequently discarded. Due to the simple alignment using existing components of most sample analysis systems installation time is reduced and reagent use may be minimised.

As described a sheath 300 may be attached to the device 1. The device 1 may in some instances comprise the sheath 300, or it may be provided separately for later attachment. The sheath 300 may be a glass sheath 300 which seals the region within the sheath 300 from the ambient environment. The sheath 300 may be a glass, quartz, or other x-ray transparent capillary as is known within the art. The sheath 300 comprises a first opening 301 and a second opening 302. The first opening 301 is for being received at the projection 103. The second opening 302 has a diameter less than the first opening 301 and is generally for the egress of the liquid sample to be analysed. A portion of the sheath 300 is arranged within a beam of electromagnetic radiation of the liquid sample analysis device 2 during use.

The sheath 300, or a portion thereof, is substantially transparent to electromagnetic radiation. The sheath 300 may be substantially transparent to electromagnetic radiation in the wavelengths corresponding to at least visible light, ultraviolet light, and/or x-ray radiation. For example, the sheath may be transparent to radiation in wavelengths from about 100 fm to about 1 μm. The portion of the sheath 300 which is substantially transparent to electromagnetic radiation is proximal the second opening 302. That is, the first opening 301 and the portion of the sheath corresponding to where the sheath 300 is received at the projection 103 need not necessarily be transparent to electromagnetic radiation. The transparency of the sheath 300 may be determined by or dependent on the wall thickness of the sheath 300 at various portions. For example, the sheath may have thinner walls proximal the second opening 302, than the first opening 301.

The sheath 300 forms a substantially sealed flow path for the liquid sample without necessitating the use of an inert gas shield, or the enclosure of the entire device 1 within an inert gas chamber. Advantageously, the sheath also allows the ability to maintain a streamline flow of liquid sample, without curling, when the liquid sample is analysed by the electromagnetic radiation.

The sheath 300 may be aligned with the longitudinal axis of extension of the projection 103, or the sheath 300 may be aligned at an angle with respect to the axis of extension of the projection 103. The sheath 300 may be arranged at an angle with respect to the base 102 of the device 1 and need not necessarily be perpendicular as shown in the figures. In the figures the projection 103 and sheath 300 each extend perpendicular from the plane formed by the base 102 of the projection 103, however, the projection 103 and/or the sheath 300 may extend at an angle such that the projection 103 and sheath 300 are not perpendicular to the plane formed by the base 102.

The projection 103 is configured for receiving and holding the sheath 300. The projection 103 may receive the sheath 300 at a shoulder region 108. The shoulder region 108 being arranged between the radial outer portion 105 of the projection 103 and the radial inner portion 104 of the projection 103. The projection 103 may comprise a first part 109 having an outer diameter greater than a second part 110. The shoulder region 108 may be arranged between the first part 109 and the second part 110. The first part 109 may itself be tapered such that it has a reducing outer diameter along the longitudinal axis. The second part 110 may extend within the sheath 300 to guide and position the sheath 300 relative to the projection 103. The sheath 300 may be fixed to the projection 103 via for example, gluing.

The at least one fluidic conduit 200 extends within the projection 103 and is for the delivery of a liquid sample to be analysed. The at least one fluidic conduit 200 forms a continuous sealed path for fluid flow. Continuous in this respect refers to the fluidic conduit forming a single path for fluid flow within the device 1. The fluid flows in one direction in the fluidic conduit 200. The at least one fluidic conduit 200 may also be referred to as uninterrupted. The at least one fluidic conduit 200 may extend within a cavity 111 within the projection 103. The cavity 111 may be configured to guide the fluidic conduit 200. The cavity 111 may form the fluidic conduit 200. The fluidic conduit may be separate element to the cavity 111, and thereby be a separate fluidic conduit 200 which is received in the projection 103. A separate fluidic conduit 200 may be formed by a tube. The fluidic conduit 200 may extend at least partially within the projection 103 and within the sheath 300. The direction of fluid flow within the fluidic conduit 200 may be towards the distal end 101 or towards the proximal end 100 of device 1. If the fluidic conduit 200 is configured for fluid flow toward the proximal end 100, then the sheath 300 is configured with the second opening 302 proximal to the proximal end 100 of the device 1. If the fluidic conduit 200 is configured for fluid flow toward the distal end 101 of the device 1 the sheath 300 is configured with the second opening 302 distal to the proximal end 100 of the device 1, in such a case the second opening 302 is proximal to the distal end 101. The at least one fluidic conduit 200 has an outlet 201 for the egress of the liquid sample. The outlet 201 is generally arranged within the sheath 300 when the sheath 300 is present. The portion of the sheath 300 which is transparent to electromagnetic radiation corresponds to the outlet 201 of the fluidic conduit 200, and downstream of the outlet 201. This enables electromagnetic radiation to be aligned with the fluid emitted from the outlet 201. The fluid conduit 200 has an inlet via which the liquid sample is received. The fluid conduit 200 is continuous and sealed between the inlet and the outlet 201. The liquid sample flows from the inlet to the outlet 201, directly, and without deviating into, for example, internal chambers or valves.

FIG. 7 shows the specimen delivery device 1 where the fluidic conduit 200 is configured to flow towards the proximal end 100 of the device 1. The projection 103 comprises a plurality of connectable elements 103a, 103b, 103c. The first element 103a comprises the shoulder 108 for receiving the sheath 300. The fluidic conduit 200 extends through the distal end 101 of the device 1 at the distal end of the first element 103a. The sheath 300 is partially covered and maintained in position by the second element 103b. The third element 103c connects to the second element 103b and comprises the base 102. The fluidic conduit 200 may exit the device 1 at the sidewall of the third element 103c. The fluidic conduit 200 may extend through each of the plurality of elements 103a, 103b, 103c.

The liquid delivered by the device 1 is a liquid sample comprising an analyte. The liquid sample may comprise microcrystals, the liquid sample may be a slurry of microcrystals. The microcrystal slurry may be comprised in known carrier mediums/fluids in the field. For example, the slurry may be comprised in a high-viscosity medium such as lipidic cubic phase, grease, agarose and other known carrier fluids. The device is generally agnostic to the carrier fluid or the specific analyte for analysis.

The device 1 shown in FIGS. 1 to 3 has an aperture 106 for the separate fluidic conduit 200. The aperture 106 is generally in the radial outer portion 105 of the projection 103. In the device of FIGS. 1 to 3, a separate fluidic conduit 200, a tube, extends through a sidewall of the projection 103. The sidewall being the outer perimeter, the radial outer portion 105 of the projection 103. The separate fluidic conduit 200 extends through the aperture 106. The aperture 106 is distal the base 102, and therefore, the magnetic sample holder 20 of the liquid sample analysis device. The fluidic conduit 200 does not pass through the base 102 of the device 1. This arrangement enables the device to be mounted to existing magnetic sample holders without modification of the sample holder.

A portion of the fluidic conduit 200 may be aligned with the longitudinal axis of the device 1. As shown in FIGS. 1-5 the entire length of the fluidic conduit 200 is not aligned with the longitudinal axis of the device 1. At least a portion of the fluidic conduit 200 is not aligned with the longitudinal axis of the device 1. Generally, at least the portion of the fluidic conduit 200 which is most proximal the base 102 of the device 1 is aligned with the longitudinal axis of the device 1. This enables the fluidic conduit 2 to exit the projection 103 at a portion of the not being the base 102.

In some instances, the fluidic conduit 200, being a separate tube, extends through the aperture 106 as is received in the cavity 111. The fluidic conduit may be a partially compliant tube such as a fused silica capillary (Polymicro Technologies LLC). The fluidic conduit 200 may have an internal diameter of from about 2 μm to about 2 mm, such as from 20 μm to 500 μm, such as from 100 μm to 500 μm, such as about 250 μm. A compliant fluidic conduit 200 which extends through the aperture 106 enables a simpler design of the projection 103 as the projection 103 need not have internal conduits/channels compatible and suitable for the delivery of the fluid sample. A single tube can be used to form a conduit for the fluid without the need for preparing inner surfaces of the projection 103. The fluid conduit 200 being the tube is sealed from the inlet which receives the liquid sample to the outlet 201 at which the liquid sample is ejected.

As described previously, in some instances the projection 103 may comprise cavities/channels forming the fluidic conduit 200. Then a separate tube is not used as the fluidic conduit 200. A connecting valve may be provided at the sidewall of the projection 103 for receiving a tube for delivery of the liquid sample. Such a configuration may ease assembly of the device 1 but may require more precise manufacturing techniques, and coatings, to be provided to the cavities/channels in the projection 103.

During delivery of a liquid sample the fluidic conduit 200 is generally connected to a pump system 3 for delivery of fluid to the device 1. The pump system 3 may for example be a syringe pump 3 configured for delivery of fluid to the device 1. The pump system 3 may be a HPLC, peristaltic or other pump system 3 for delivery fluid samples. The pump system 3 is connected to the fluidic conduit 200 of the device 1. The liquid delivered with the device is a substantially continuous liquid stream. A typical syringe pump comprises a syringe, a means of actuating the plunger of the syringe, and a control system for controlling the actuation means.

As shown in FIG. 2, in some instances the device 1 may comprise a plurality of fluidic conduits 200a,200b each for delivery of a fluid. If the device 1 comprises a plurality of fluidic conduits 200a, 200b then at least one of the conduits 200 is for the delivery of a liquid sample, whilst the other fluidic conduits 200 may be for the delivery of a liquid sample or a gas. In FIG. 2 both fluidic conduits 200a, 200b are for the delivery of a liquid sample. Each of the fluidic conduits 200 form a respective continuous sealed path for the flow of a fluid e.g., a liquid sample.

At least one of the fluidic conduits 200a, 200b may be arranged radially central of at least one of the other fluidic conduits 200a, 200b. At least a portion of the radial central fluidic conduit 200 may be co-axial with the central longitudinal axis of the projection 103.

If the device 1 comprises a plurality of fluidic conduits 200a, 200b then the outlets 201a, 201b of the conduits 200a, 200b may be aligned such that fluid exiting the outlets 201a, 201b exits at substantially the same longitudinally position with respect to the device 1. The outlets 201a, 201b may be, as shown in FIG. 2, non-aligned such that one of the outlets 201a, extends further longitudinally within the device 1 with respect to the other outlet 201b. Such an arrangement reduces mixing time of the liquids exiting the fluidic conduits 200a, 200b, before being analysed by the liquid sample analysis device.

If the device 1 comprises a plurality of fluidic conduits 200a, 200b then the conduits may meet and be combined such that the fluidic conduits 200a, 200b have a single outlet 201. The point at which the conduits 200a, 200b meet may be within the projection 103. The fluids provided to the conduits may therefore mix prior to exiting the fluidic conduit 200.

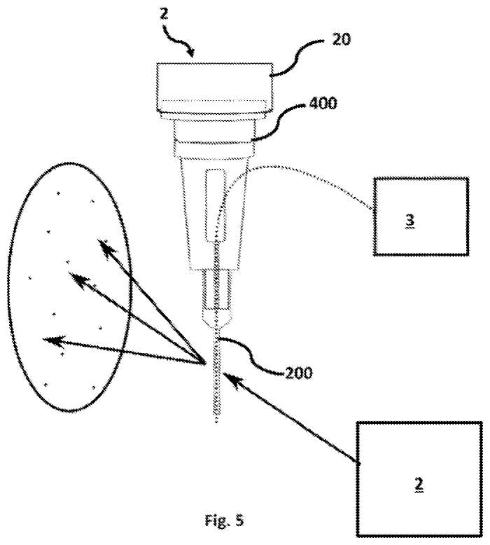

FIG. 4 shows a gas delivery sleeve 500 arranged to receive the projection 103, the gas delivery sleeve is for the delivery of a gas. The gas delivered by the sleeve 500 may flow around the liquid delivered by the fluidic conduit 200. In some instances this gas may be used to guide the liquid. The gas may be used to form an inert environment near the outlet 302, and/or to deliver ligands to the liquid sample. The gas delivery sleeve 500 has a proximal end 501 and a distal end 502. The proximal end 501 is provided with a recess 504 for receiving the distal end 101 of the projection 103. The recess 504 extends longitudinally through the gas delivery sleeve 500. The recess 504 has a first opening at the proximal end 501 which is large enough to receive the projection 103 and the sheath 300. The recess 504 has a second opening at the distal end 502 which is adapted to fit around the sheath 300, but not the projection 103. The second opening has a smaller diameter than the first opening. The gas delivery sleeve has an outlet 503 provided at the distal end 502. The outlet 503 is in connection with a gas conduit 510. The gas delivery sleeve enables the provision of a gas simultaneously with the delivery of the liquid sample from the device 1. For example, an inert gas such as nitrogen, or helium may be provided to the gas conduit 510 and flow from the outlet 503.

The projection 103 is advantageously made from a polymer. The projection 103 is designed to be easily manufacturable and generally lacks complex geometries, internal pumps, valves, plungers, actuators etc. The projection may be manufactured via an injection moulding process, an additive manufacturing process or the like. A polymer projection 103 has the advantage that it is generally lighter and cheaper to manufacture than a similar formed projection made from metal. A polymer projection 103 is ideal for the device 1 described herein as it lacks internal plungers/pistons/actuators for delivering the fluid.

As stated previously the device 1 is configured to be releasably connectable to the magnetic sample holder 20 of a liquid analysis sample device 2. The magnetic sample holder 20 may be the magnetic base of a goniometer head. The base 102 of the device 1 is adapted to receive a ferrous and/or magnetic connecting element 400. The connecting element 400 abuts and releasably engages with the magnetic sample holder 20 of the liquid sample analysis device 2. The base 102 may be formed to align and engage with the magnetic sample holder 20 itself, or the base 102 may be provided with an additional and separate connecting element 400 which engages with the magnetic sample holder 20.

SPINE HT caps are an example of a separate connecting element and holder design which have been used within sample analysis systems to hold single crystals and have not been used in the delivery of continuous liquid samples to an analysis device. The connecting element 400 may be a CrystalCap SPINE HT cap (Hampton Research LLC). The base 102 therefore has suitable dimensions for receiving such a cap. The base 102 may have an outer diameter of approximately 7.8 mm at the most proximal point.

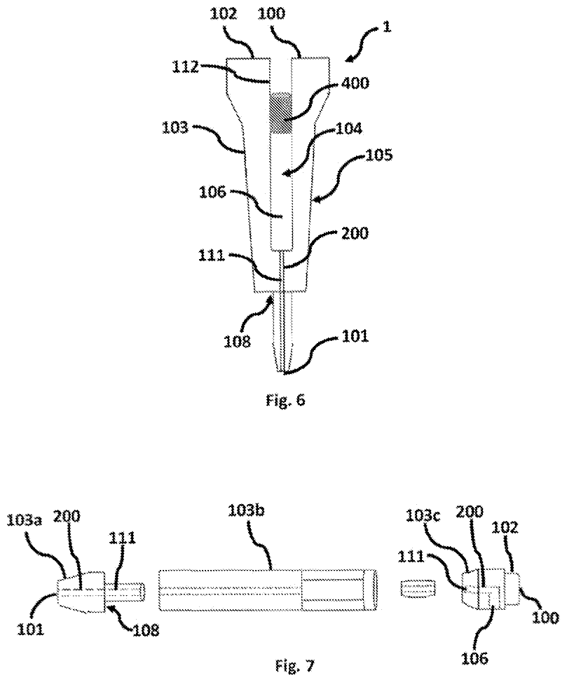

As shown in FIG. 6 the base 102 may comprise a recess 112 to receive a connecting element 400 being magnetic metallic element 400. The recess 112 is at the radial inner portion 104 of the projection 103. The recess 112 may be aligned with the longitudinal axis of the device 1. The recess 112 extends from the proximal end 100 of the device 1 inwards towards the distal end 101 of the device 1. The recess 112, the aperture 106, and the cavity may be connected and form a single longitudinal channel within the projection 103. The magnetic metallic element 400 may be received partially within the recess 112, such that a projection of the magnetic sample holder is received partially within the recess 112. The base 102 is adapted to be received on the magnetic sample holder 20 of a liquid sample analysis device. In such a design the device 1 does not comprise the CrystalCap SPINE HT connecting element, the base 102 is adapted to receive the magnetic sample holder 20 itself. The base 102 and the projection 103 may be formed by a single element to ease manufacturing and assembly processes. The magnetic metallic element is generally a ferrous metallic element.

The projection 103 of the device 1 may have a length of from about 10 mm to about 50 mm. The devices of FIGS. 1 to 5 have projections 103 having a length of approximately 34 mm. The total length of the device when the connecting element 400 and sheath 300 are located on the device 1 is from about 40 mm to about 60 mm such as from about 50 mm to about 55 mm.

The sheath 300, the fluidic conduit 200, and the connecting element 400 are each fixed to the projection 103. Each may be fixed via, for example, gluing.

A method of producing a device 1 will now be described.

Providing a projection 103 as described herein.

Providing at least one separate fluidic conduit 200, being formed by a compliant tube, to the projection 103. The separate fluidic conduit 200 may be inserted through the distal end 101 of the projection 103 and received in the cavity 111 within the projection. The fluidic conduit exits the sidewall of the projection via the aperture 106.

Attaching a sheath 300 at a shoulder portion 108 of the projection 103.

Attaching a connecting element 400 at the base 102 of the device 1.

Optionally, cutting the fluidic conduit 200 and the sheath 300 to a desired length.

FIG. 5 shows a schematic of a system comprising the device 1, a liquid sample analysis device 2, and a pump 3. The magnetic sample holder 20 is shown in connection to the connecting element 400. The arrows indicate a beam for analysing the liquid sample, which is shown with the dotted line. The arrows may represent an x-ray beam from a synchrotron radiation source or from an XFEL source. The circle filled with dots may represent an x-ray detector detecting the scatted pulse of the x-ray beam. The beam for analysing the sample may be directed at a portion of the sheath 300 as is shown in FIG. 5. The beam may be directed downstream of the outlet 302 of the sheath 300, that is, the beam need not be directed through the sheath 300 in all instances and uses. The pump 3 provides the liquid sample for analysis. The pump 3 is connected to the inlet of the fluidic conduit 200. The volume flow-rate of the pump 3 determines the volume flow-rate of the liquid sample at the outlet 201 of the fluidic conduit 200. As the fluidic conduit 200 is continuous within the specimen delivery device 1, the volume flow-rate at the inlet of the fluidic conduit 200 is the same as the volume flow-rate at the outlet 201 of the fluidic conduit 200. The flow-rate at the outlet 201 of the fluidic conduit 200 is determined and controllable via the pump 3.

The beam of electromagnetic radiation has been described as generally being an x-ray beam. The device 1 may be provided with a plurality of beams of electromagnetic radiation at different wavelengths. For example, a UV and/or visible beam may be directed at the device for combined x-ray and UV/visible interrogation of the sample. The system may therefore comprise at least one beam, a plurality of beams etc.

A method of analysing a liquid sample via a liquid sample analysis device 2 will now be described. The liquid sample within the device 1 generally deflects, scatters, absorbs, or fluoresces electromagnetic radiation when exposed to at least one beam, the method comprises: arranging the specimen delivery device 1 as described herein in a sample analysis device 2 by connecting the base 102 to the releasable magnetic sample holder 20 of the device 2.

Providing a liquid sample to the fluidic conduit 200.

Subsequently, submitting the liquid sample to the beam of electromagnetic radiation.

The liquid sample is provided by the pump 3, the flow at the outlet 201 of the fluidic conduit 2 is provided by the pump 3. The liquid sample is generally provided as a continuous flow. In particular, the pump 3 may force the liquid sample through the fluidic conduit 200 during analysis of the liquid sample, that is, whilst the liquid sample is being submitted with the beam of electromagnetic radiation. The volume flow-rate of the pump 3 determines the volume flow-rate of the fluid at the outlet 201 of the fluidic conduit 200. As described previously, there are no internal plungers or actuator mechanisms within the device 1 which force the liquid sample from the fluidic conduit 200. Due to the device 1, an in particular due to the sheath 300 fluid samples do not need to be self-supporting, or supported via a gas delivery sleeve as in known injector devices.

As described above the sheath 300 may be arranged within the beam of electromagnetic radiation such that the beam is incident the sheath 300. As at least a portion of the sheath 300 is substantially transparent to electromagnetic radiation the beam passes through the sheath 300 and the liquid sample scatters, reflects, absorbs, deflects the beam.

Although, the present invention has been described above with reference to specific embodiments, it is not intended to be limited to the specific form set forth herein. Rather, the invention is limited only by the accompanying claims.

In the claims, the term “comprises/comprising” does not exclude the presence of other elements or steps. Furthermore, although individually listed, a plurality of means, elements or method steps may be implemented by e.g., a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1-19. (canceled)

20. A specimen delivery device for the delivery of a liquid sample to be analysed comprising:
a proximal end, and a distal end, the distal end longitudinally displaced from the proximal end,
a base at the proximal end for releasable connection to a magnetic sample holder of a liquid sample analysis device,
a longitudinally extending projection having a radial inner portion, the projection extending from the base towards the distal end, the projection adapted for receiving and holding a sheath,
at least one fluidic conduit for the delivery of a liquid sample for analysis, the fluidic conduit extending at least partially longitudinally within the radial inner portion of the projection, the fluidic conduit provided with an outlet, and forming a continuous sealed path for fluid flow to the outlet.

21. The specimen delivery device of claim 20, wherein the fluidic conduit extends towards either the distal end or the proximal end of the device.

22. The specimen delivery device according to claim 20, wherein the fluidic conduit extends through the sidewall of the projection distal the base.

23. The specimen delivery device according to claim 20, wherein the projection comprises a radial outer portion, and wherein an aperture is provided in the radial outer portion, and wherein the fluidic conduit extends through the aperture.

24. The specimen delivery device according to claim 20, wherein the base comprises a recess, the recess comprising a connecting element, the connecting element for releasable connection to a magnetic sample holder.

25. The specimen delivery device according to claim 20, wherein the device comprises the sheath.

26. The specimen delivery device according to claim 20, wherein at least a portion of the sheath is substantially transparent to electromagnetic radiation.

27. The specimen delivery device according to claim 26, wherein the portion of the sheath proximal a second opening of the sheath is substantially transparent to electromagnetic radiation.

28. The specimen delivery device according to claim 25, wherein the outlet of the fluidic conduit is arranged within the sheath.

29. The specimen delivery device according to claim 25, wherein the sheath is receivable at a shoulder region between the radial outer portion and the radial inner portion of the projection.

30. The specimen delivery device according to claim 20, wherein releasable connection at the base of the device enables alignment of the device within the liquid sample analysis device.

31. The specimen delivery device according to claim 20, wherein at least one tubular fluidic conduit extends through the aperture in the radial outer portion of the projection and forms the fluidic conduit.

32. The specimen delivery device according to claim 20, wherein the projection is made from a polymer.

33. A method of analysing a liquid sample via a liquid sample analysis device, the device emitting electromagnetic radiation in at least one beam, the method comprising:
arranging the specimen delivery device according to claim 20 in a liquid sample analysis device by connecting the base to the releasable magnetic sample holder of the device,
providing a liquid sample to the fluidic conduit, and
submitting the liquid sample to the beam of electromagnetic radiation.

34. The method according to claim 33, wherein the specimen delivery device comprises the sheath and wherein the method comprises:
arranging the sheath such that the beam of electromagnetic radiation is incident the sheath.

35. The method according to claim 33, wherein the method comprises providing a continuous flow of liquid sample to the fluidic conduit when the liquid sample is submitted to the beam of electromagnetic radiation.

36. A system for the provision of a liquid sample to a liquid sample analysis device, the system comprising
a specimen delivery device according to claim 20,
a pump for the provision of the liquid sample to the specimen delivery device, wherein the pump is connected to an inlet of the fluidic conduit of the specimen delivery device, and wherein the liquid is provided at a volume flow-rate determined by the pump.

37. The system according to claim 36, wherein the flow of fluid at the outlet of the fluid conduit is controllable via the pump.

38. The system according to claim 36, wherein the system comprises a liquid sample analysis device for emitting at least one beam of electromagnetic radiation, wherein the specimen delivery device comprises the sheath and wherein the sheath is arrangeable such that the at least one beam of electromagnetic radiation is incident the sheath.
